(19) United States
(12) Patent Application Publication
(10) Pub. No.: US 2010/0094440 A1
(43) Pub. Date: Apr. 15, 2010

(54) Externally-connected audio apparatus and method for processing audio signals thereof

(76) Inventors: Yi-Chun Huang, Taipei City (TW); An Pang Li, Taishan Township (JP); Tsuo-Ming Ho, Jhonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/385,816

(22) Filed: Apr. 21, 2009

(30) Foreign Application Priority Data
Oct. 15, 2008 (TW) 97139541

(51) Int. Cl. G06F 17/00; G06F 13/00; G06F 12/02

(52) U.S. Cl. 700/94; 710/300; 711/170; 711/E12.002

(57) ABSTRACT

An externally-connected audio apparatus and a method for processing the audio signals are described. This approach is primarily to improve the externally-connected audio quality by applying a memory sharing mechanism into an audio apparatus. Preferably, the audio apparatus has one end connected to a computer system through an interface control unit, and another end outputting or receiving external audio signals through an audio interface unit. A memory control unit is particularly introduced to be an arbiter for the built-in buffer memories—including the memory for storing the data transmitted through the interface control unit, and the memory for buffering the data to be analog-digital conversion. The memory control unit is to control the data buses of buffer memories and determine whether a sharing mode is activated or not. One of the objectives is to increase the capacity for buffering the audio signals so as to enhance the audio quality.

### BACKGROUND OF THE INVENTION

1. Field of the Invention

The present invention relates to an externally-connected audio apparatus and a method for processing audio signals, more particularly, a memory controller is introduced to integrate random access memory in the apparatus in order to enhance audio processing.

2. Description of Related Art

In addition to or alternatively to the conventional audio processing chip and its interfacing ports disposed in most computer systems, an external USB audio device may be connected to a computer through a universal serial bus (USB). Thereby, the computer system transmits digital audio signals to the USB-connected audio device, and a microprocessor therein periodically processes the audio signals. For example, the USB-connected system uses a transmission rate with once per 0.001 second to process audio signals. If a burst of sound occurs, the data may be transmitted completely in a very short time, such as 150 ms. According to the aforementioned approach, a buffer memory shall be used in this USB-connected audio device for buffering the great quantity of data sent from the computer system.

Reference is made to FIG. 1, an externally-connected audio device 10 is schematically shown connected to a computer 12, and the interface interconnected is often a USB. The externally-connected audio device 10 has two I/O ports. One of them is a headset socket 15 used for outputting analog or digital audio through an output device, such as an earphone or a speaker. Another port shows a microphone socket 18 that is used for inputting other audio sources.

The mentioned externally-connected audio device 10 has an internal buffer memory with limited capacity, and the capacity should be in accordance with a certain requirement. For example, the capacity of the memory shall have a minimum buffer space of the multiplication of sampling rate, data word length, and the number of channels in use as processing the audio signals. After that, this externally-connected audio device 10 at least has two types of interfaces, including analog and digital types, which is used for outputting the inputted audio signals. The interior circuit of the externally-connected audio device of the prior art is schematically shown in FIG. 2.

FIG. 2 shows the externally-connected audio device 10 internally having two independently-operating memories, which are used by an interface controller 101 and a digital-analog converter. One end of the externally-connected audio device 10 is used to connect to the computer system 12, and another end thereof is used to transmit analog audio signals 14 or digital audio signals 16 via multiple I/O ports. Furthermore, this externally-connected audio device 10 includes an interface controller 101 used for transmitting the processed signals, and a buffer memory 111 is incorporated to buffer the transmitted signals.

Through the bus 103, the mentioned interface controller 101 and the circuit of the audio interface module 105 are electrically interconnected. The audio interface module 105 is the circuit for processing the audio signals, and includes an analog audio interface unit 113 for processing the converted signals, and a digital audio interface unit 117 for processing digital audio signals. The analog audio interface unit 113 is similar to an analog-digital converter which can convert the digital signals sent from the computer system 12 into analog signals and output the analog audio signals 14. On the other hand, the analog audio interface unit 113 may convert the externally inputted analog signals 14 into digital signals. A memory 115 is further disposed to buffer the signals.

The mentioned digital audio interface unit 117 is used for processing digital signals. In one example, if the computer system 12 outputs digital audio signals via the externally-connected audio device 10, there is no need to use analog-digital conversion, but use the digital audio interface unit 117 to output digital signals 16.

### SUMMARY OF THE INVENTION

In view of the mentioned conventional art, the limited data storage constrains the signals processing capability of an externally-connected audio apparatus since the apparatus has limited buffer memory. In particular, an externally-connected audio apparatus described in the present invention utilizes a memory control circuit to control each independent memory therein. By means of sharing the memories, the audio quality may be improved as it is capable of processing larger data throughput.

One object of the present invention is to enhance the capability of processing audio signals by means of sharing the memories of the externally-connected audio apparatus, so that idle memory may be adequately used. Another object is to improve the audio quality, including to increase the sampling rate, or to process longer data word length.

In which, the externally-connected audio apparatus of the present invention may be implemented as plural embodiments. According to the preferred embodiment, the externally-connected audio apparatus includes an interface control unit, and the apparatus is connected to a computer system via a connecting interface. Furthermore, a first memory is included to buffer the signals. An audio interface module is also included for performing a digital-analog conversion in the externally-connected audio apparatus. A second memory is included for buffering the signals. Through the audio interface module, the apparatus may be connected with an external audio source or other signal receiver. The present invention mainly uses a memory control unit to allocate the usage space of the first memory and the second memory. Therefore the audio quality can be improved even though only limited resource is used.

In another embodiment, the externally-connected audio apparatus uses the memory control unit to integrate the memory circuits disposed in the apparatus in addition to having the above-mentioned digital and analog interface control units.

The signal processing method applied to the externally-connected audio apparatus simply includes a first step to receive the signals transmitted from the computer system by the audio apparatus. Next, the signals are converted into the format in compliance with the certain interfacing format, such as USB. Next, the memory control circuit determines the usage status for each memory in the apparatus. If the memory to be shared is occupied by an application, an independent mode is enabled. After that, the apparatus addresses the single memory, writes data on it, and outputs audio. On the other hand, if the memory to be shared is not occupied, a sharing mode is enabled. Then the apparatus addresses and writes data on the memory, and outputs audio.

According to the second embodiment of the present invention, the apparatus receives audio signals from an external audio source, it is not necessary to perform analog-digital conversion on the audio signals if they are digital signals. However, if the audio signals are analog signals, the audio apparatus will perform analog-digital conversion on them. After receiving the audio signals, the memory control circuit will detect the usage status of each memory to be integrated in the externally-connected audio apparatus. Next, the circuit determines whether the memory to be shared is occupied or not. If the memory to be shared is not be occupied, the memory control circuit addresses the shared memories, and writes data after arbitration. After that, the apparatus outputs data to the computer system.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram showing the connection between an externally-connected audio apparatus and a computer in the prior art;

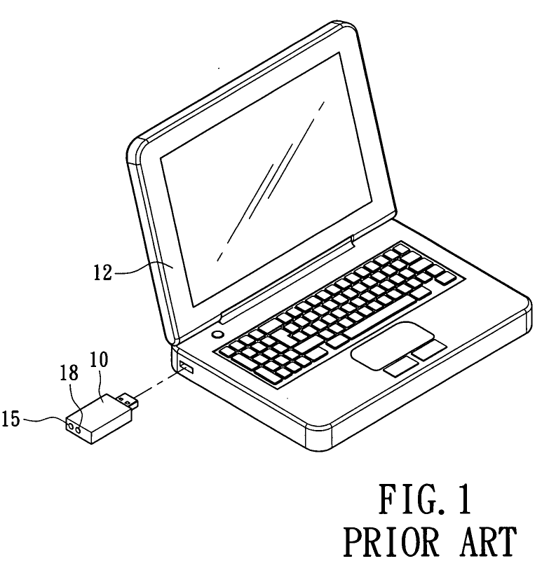

FIG. 2 is an electrical block diagram of the externally-connected audio apparatus of the prior art;

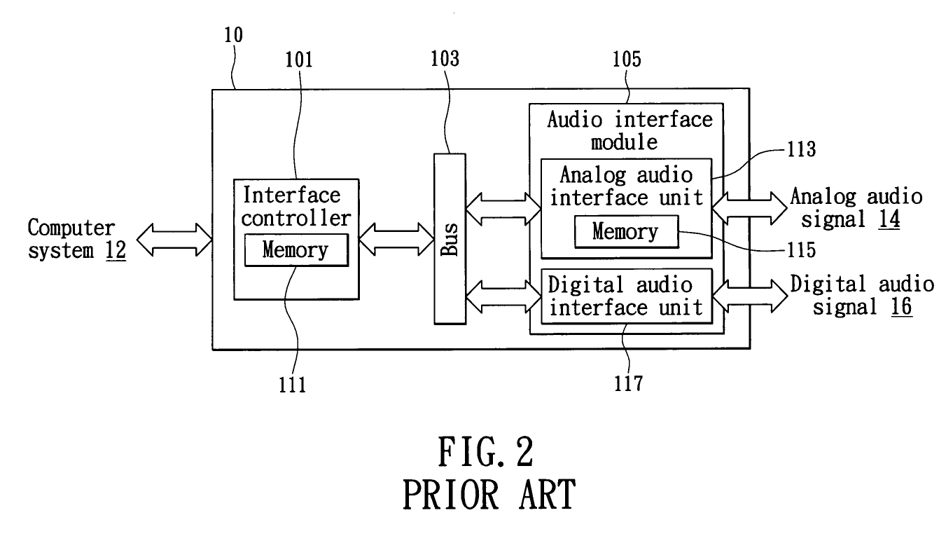

FIG. 3 shows an electrical block diagram of the externally-connected audio apparatus of first embodiment of the present invention;

FIG. 4 shows an electrical block diagram of the externally-connected audio apparatus of second embodiment of the present invention;

FIG. 5 shows an electrical block diagram of the externally-connected audio apparatus of third embodiment of the present invention;

FIG. 6 shows a flowchart of the method for processing audio signals of first embodiment of the present invention;

FIG. 7 shows a flowchart of the method for processing audio signals of second embodiment of the present invention.

### DETAILED DESCRIPTION OF THE PREFERRED EMBODIMENTS

The present invention is illustrated with a preferred embodiment and attached drawings. However, the invention is not intended to be limited thereby.

Generally speaking, an external audio device may be the device for processing audio for a computer system. A delta-sigma DAC may embody a digital-analog conversion, which converts the received digital audio signals to analog signals, made by this externally-connected audio apparatus. In particular, a memory for buffering those signals is included. The circuit for processing digital audio signals is specified by some digital audio transmission interfaces, such as I2S (Inter-IC Sound), SPDIF (Sony/Philips Digital Interconnect Format), and DSD (Direct Stream Digital).

In view of the drawback of only limited buffer memory existed in the conventional external audio device, the present invention particularly provides an externally-connected audio apparatus and the method for processing audio signals to develop a memory control (or memory arbitration) mechanism. In which, a control circuit is utilized to integrate the random access memories in the apparatus, which may enhance the data processing capability by means of sharing memory, in order to improve the audio quality.

For adequately utilizing the memories separately disposed in some circuits of the externally-connected audio apparatus, the present invention develops a dual-mode memory control circuit that can operate in a traditional independent mode or a sharing mode. For example, when the analog (analog audio interface unit) and the digital (digital audio interface unit) audio interface units shall be activated simultaneously, the memory control circuit operates in the independent mode. In the meantime, the connected memories work for their original process separately. That is, the build-in analog audio interface unit (commonly the delta-sigma DAC) having its own memory and an interface control unit (commonly the USB controller) operate normally, and the physical memories therein work independently.

In another situation, when the analog audio interface unit is deactivated and only the digital audio interface unit is on, the mentioned memory control circuit operates in the sharing mode. In the meantime, the interface control unit peculates the memory originally used for the analog audio interface unit in order to increase the applicable memory.

In general, the sampling rate with higher frequency or longer word length may enhance the audio quality, whereas both ways need bigger buffer memory. Thus the way disclosed in the present invention can increase the applicable buffer memory of the externally-connected audio apparatus, but without further increment of the area of silicon chip therein. What follows is the detailed disclosure of the random access memory built in the externally-connected audio apparatus of the present invention.

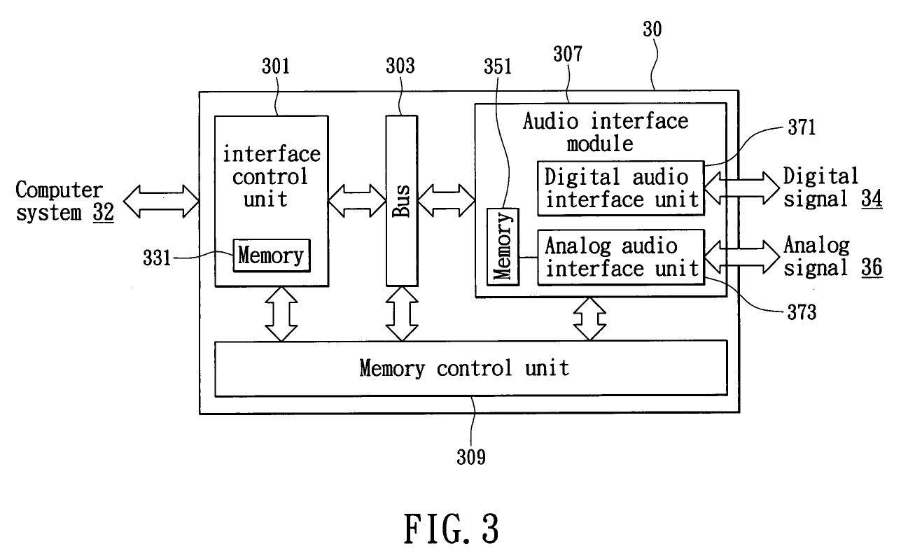

Reference is made to FIG. 3 showing an electrical block diagram of the externally-connected audio apparatus of the present invention. An externally-connected audio apparatus 30 is shown, wherein one end of the apparatus 30 connects to a computer system 32 by an interface control unit 301 via a connecting interface, and the other end of the apparatus 30 connects to an external device through an audio interface module 307.

The interface control unit 301 is realized as a controller of the universal serial bus (USB) in one of the preferred embodiments. By way of this USB interface, the externally-connected audio apparatus 30 connects with the computer system 32. Furthermore, by way of the audio interface module 307, the externally-connected audio apparatus 30 connects to external analog or digital audio sources or any similar receiver via one or more I/O ports. The I/O ports thereto may be the analog ports connected to earphone or speaker, or the ports outputting digital audio signals, or the input port of microphone, or other audio sources.

According to the preferred embodiment, the audio signals are transmitted between the externally-connected audio apparatus 30 and the computer system 32 via the interface control unit 301. The audio interface module 307 includes a digital audio interface unit 371 and an analog audio interface unit 373. The digital audio interface unit 371 is used to process the digital audio signals (34), and connected to the external digital sources or the relevant device. The analog audio interface unit 373 is used to perform conversion between digital and analog signals, including the conversion of the digital signals received from the computer system 32 via the interface control unit 301 into analog signals. After that, the analog signals are outputted to an external device. On the other hand, the analog audio interface unit 373 also receives the external analog signals and converts them into digital signals.

In the present case, the interface control unit 301 includes a buffer memory 331 for buffering the signals transmitted between the externally-connected audio apparatus 30 and the computer system 32. The capacity of the buffer memory 331 affects the performance of audio processing. Furthermore, the audio interface module 307 includes its own memory 351 for buffering the audio signals requiring for analog-digital conversion (305). The memory 351 is electrically connected to the analog audio interface unit 373, and in charge of buffering the signals therethrough. A memory control unit 309 is preferably disposed in the externally-connected audio apparatus 30, and electrically connected to the buffer memories 331, 351 of the mentioned interface control unit 301 and the audio interface module 307. The memory control unit 309 is used to allocate usage of the memories 331, 351.

In a practical implementation of the memory control unit 309, the memory control unit 309 simultaneously connects to the interface control unit 301, bus 303 and the audio interface module 307, and a bus 303 is used to transmit the signals therebetween. The memory control unit 309 respectively connects to the memories 331, 351 of the interface control unit 301 and the audio interface module 307. In the situation without any digital-analog conversion, that is only the digital signals in process, the analog audio interface unit 373 is in idle status. In the meantime, the memory control unit 309 is activated as the sharing mode. The way to buffer the signals may have two approaches, which are directed to higher sampling rate and longer data word length respectively. If the memories 331, 351 disposed in the interface control unit 303 and the analog audio interface unit 373 have the same volume, the double spaces of the memory may be used. In this exemplary example, the sampling rate is increased from 48 kHz to 96 kHz.

In the mentioned sharing mode, the data to be processed can be twice than the data processed in the conventional operation. The data buffered in each address bus for the memories 331, 351 contains the same content, and each of them stores 50% of the buffered data written or read through the data bus. According to the other approach of the sharing mode, when the data word length increases from 16 bits to N bits and N is an integer bigger than 16, each address bus for the memories 331, 351 contains the same content at every occurrence of writing or reading. For example, when the data of first bit through sixteen bit is written into the memory 331, the remaining data of N-16 bits is written into the memory 351. The memory control unit 309 of the present invention merely controls the data bus for the memories 33 1, 351, but no need to handle the address bus, so that it reduces the design complexity.

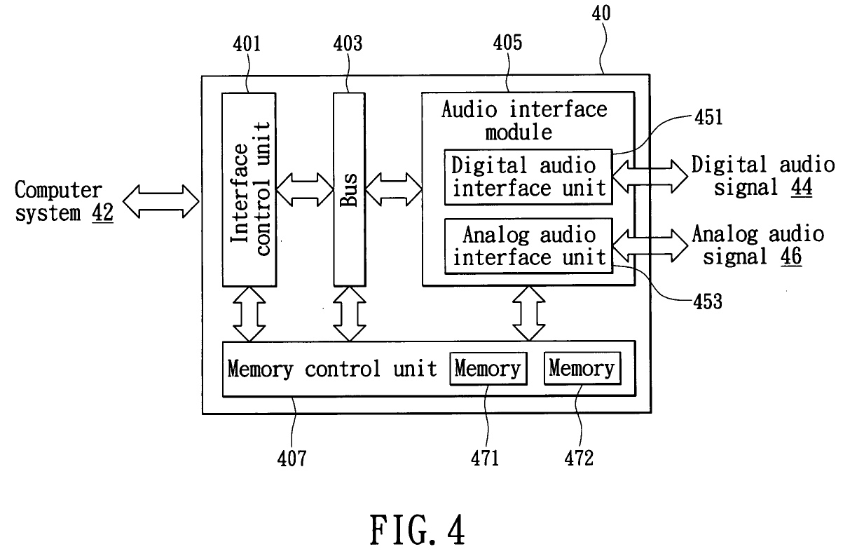

Please further refer to FIG. 4 showing an electrical block of the externally-connected audio apparatus of the second embodiment. Both circuits for processing analog audio signals and digital signals are disposed in the externally-connected audio apparatus 40. Furthermore, a memory control unit 407 for controlling data access is utilized to flexibly allocate idle memory.

The externally-connected audio apparatus 40 shown in the diagram is used to interconnect a computer system 42 and an external audio source or audio output device. Preferably a USB interface is used to connect the computer system 42 to an external audio system. The externally-connected audio apparatus 40 includes an interface control unit 401 used to transmit data or receive data from the computer system 42, and the interface control unit 401 electrically connects to an audio interface module 405 via bus 403. The audio interface module 405 includes an input interface and an output interface, thereby outputting the audio signals converted from analog signals of the external audio source or from digital signals produced by the computer system 42, or to transmit the digital signals converted from the external analog signals to the computer system 42. In this case the audio interface module 405 has a digital audio interface unit 451 and an analog audio interface unit 453.

According to the preferred embodiment, the signals become output digital signals 44 by passing through the digital audio interface unit 451 if the external audio source is a digital source, or a digital receiver such as the source directed to an optical fiber or other output. Otherwise, the analog audio interface unit 453 performs a digital-analog conversion if the received or outputted signals are analog signals 46.

Particularly, a memory control unit 407 is disposed in the externally-connected audio apparatus 40 of present invention. In an exemplary example, the externally-connected audio apparatus 40 directly utilizes the memory control unit 407 to integrate every memory circuit originally disposed in the apparatus 40. The memory control unit 407 preferably connects to a first memory 471 applied for the interface control unit 401 and a second memory 472 used for buffering the signals using digital-analog conversion in the audio interface module 405. Alternatively, a circuit module is utilized to place the memories inside.

As the above-mentioned example, if the externally-connected audio apparatus 40 handles the digital signals, the second memory 472 applied for the audio interface module 405 is in an idle state. In the meantime, the memory control unit 407 operates as the sharing mode, and integrates the first memory 471 and the second memory 472. On the other hand, if the externally-connected audio apparatus 40 handles the analog signals, the memory control unit 407 activates in the independent mode. In this independent mode, the first memory 471 and the second memory 472 are respectively used for buffering the signals transmitted through the interface, or in the signal conversion.

In one preferred embodiment, the externally-connected audio apparatus 40 includes a micro-control unit (MCU) which may provide more functions for signal processing in addition to original process. For example, the MCU may performs volume control, audio analog-digital conversion, and power management. In another preferred embodiment, the circuit forming the audio interface module shown in FIG. 3 and FIG. 4, or forming the analog-digital converter of the audio interface module may be included in the MCU, and use the buffer memory inside.

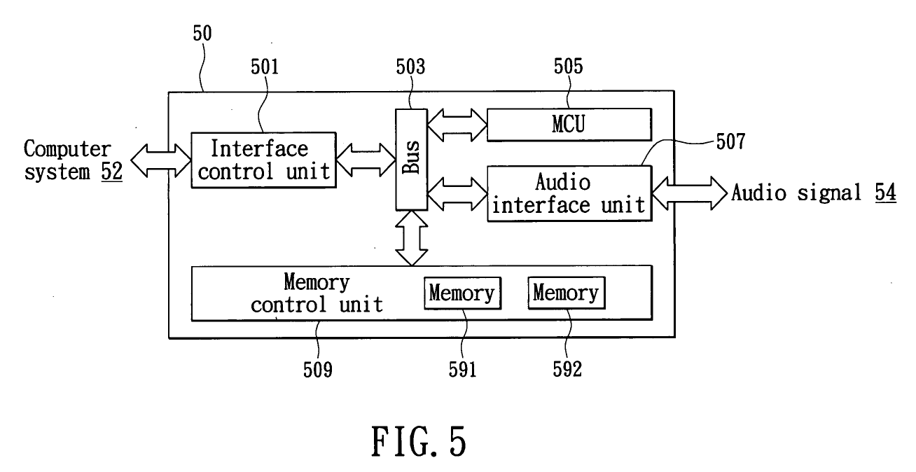

The standard framework of a MCU has embedded data memory (RAM) with at least 256 bytes, that is utilized in the schematic diagram of the structure shown in FIG. 5. In which, the first memory 591 of an interface control unit 501 and the second memory 592 of the MCU 505 are shared for the apparatus by the memory control unit 509.

Referring to FIG. 5, one end of the externally-connected audio apparatus 50 connects to a computer system 52 via the interface control unit 501, and the other end of the externally-connected audio apparatus 50 connects to an external audio source or an output device (54). Inside the apparatus 50, by way of a bus 503, the interface control unit 501, the micro-control unit 505, an audio interface unit 507 and a memory control unit 509 are interconnected electrically. In the exemplary example, the memory control unit 509 is used to integrate the first memory 591 used to buffer data in the interface control unit 501, and the second memory 592 disposed inside the MCU 505. A sharing mode is provided for this scheme that shares the space combined with these two memories 591, 592. Furthermore, an independent mode is provided for independent work of the two memories 591, 592.

As the externally-connected audio apparatus 50 is under process, the inside MCU 505 may be used to perform an analog-digital conversion. The signals undergoing this conversion pass through a bus 503, and being outputted via the audio interface unit 507. This audio interface unit 507 is also used to receive audio signals 54. After the conversion processed on the audio signals via MCU 505, the signals may be transmitted to the computer system 52 via the interface control unit 501. In the sharing mode, the applicable memory capacity for each read/write process of data becomes bigger. In the moment, the memory control unit 509 controls the address the data writes by allocating the address buses and data buses to the memories 591, 592.

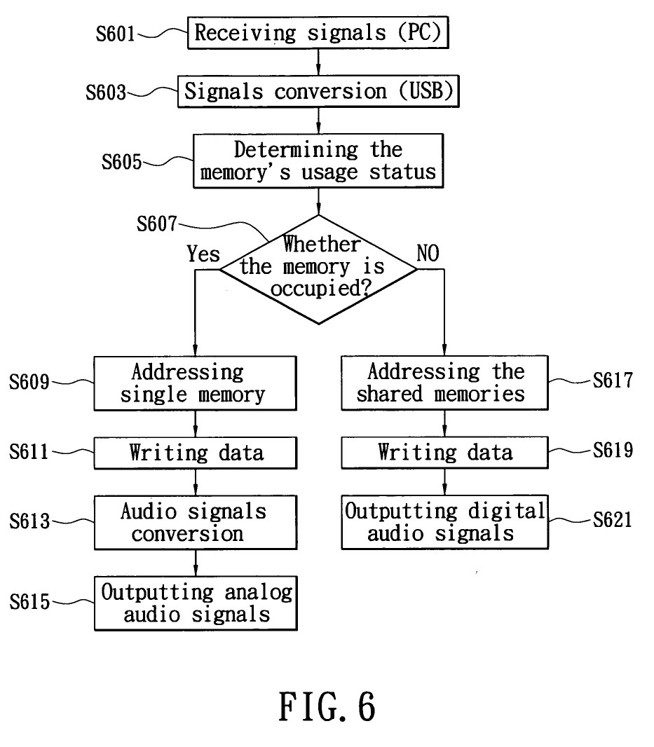

Reference is made to FIG. 6, which shows a flow chart illustrating the method for processing audio signals using the claimed externally-connected audio apparatus. At the first step S601, this externally-connected audio apparatus receives the signals sent from a computer system. The interface therebetween is preferably implemented as a USB, therefore, the signals may firstly be processed in an interface control unit in a format transformation for a specific interfacing standard (step S603). The alternative way using a serial link such as IEEE 1394, Ethernet, or HDMI may be used. Preferably, a digital connecting interface, which adopts the minimum unit in a form of packet, is used for the serial link.

After that, the memory control unit determines the usage status for each memory (step S605), that is to determine how the memories work for the externally-connected audio apparatus, including whether or not the memories are occupied by any application, such as to buffer the data in the analog-digital conversion (step S607). If the memory to be shared is occupied (yes) since it may be used as a buffer for the digital-analog conversion, an independent mode is launched. Each memory inside the apparatus works independently at this moment. The step S609 illustrates how the audio signals are processed, in which, it is to address a single memory such as the buffer memory for the interface control unit, and to perform data writing in step S611, digital-analog conversion in step S613, and analog audio signals outputting in step S615.

In the example of outputting digital audio signals, if the memory control unit determines the memory is available to be shared, it is to address the shared memories (step S617). If the applicable memory increases, the data available for processing becomes bigger. After addressing the memories via the memory control unit, each memory reads or writes on average 50% of the data. Alternatively, the data may be written in the shared memories in sequence, that is, the second memory is standby for writing data as filling the first memory. Particularly, the present invention reduces the circuit's complexity because the memory control unit merely allocates the data bus for each memory but not the address bus.

After that, the data is written into the memories in accordance with the allocated addresses (step S619), and outputted (step S621).

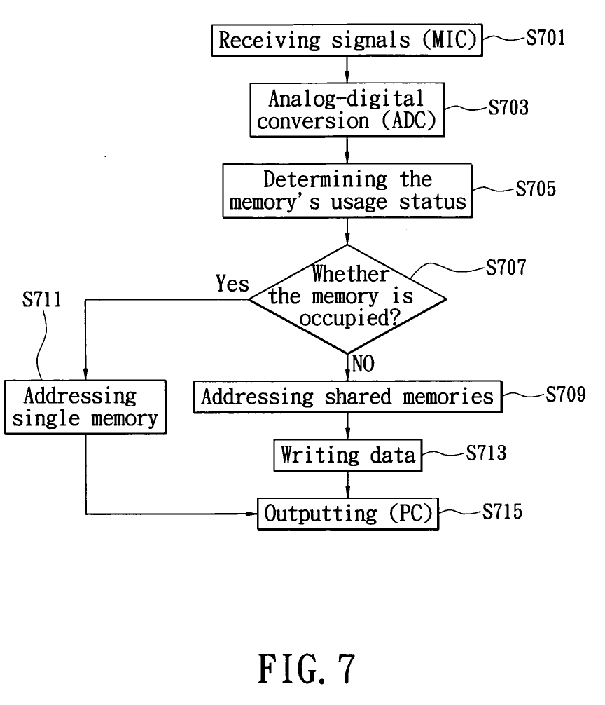

A flow chart illustrating the method for processing audio signals in FIG. 7 is an embodiment of receiving the signals from an external analog audio source.

In the beginning of the steps, said externally-connected audio apparatus receives audio signals from an external source, such as the analog signals produced by a microphone, or other digital signals made by other sources (step S701). If the inputted signals are digital signals, there is no need to perform analog-digital conversion since the receiving end is a computer system. Otherwise, if the inputted signals are analog signals, an analog-digital conversion is necessary to be performed in the apparatus (step S703). After the signals are converted into digital signals, the memory control unit determines the usage status of each memory in the apparatus (step S705). Further, it is determined whether the memory to be shared is occupied or not (step S707).

If the memory is determined to be occupied (yes), it shows the memory is in process, for example, the memory is used to buffer other data. The memory control unit addresses a single memory such as the buffer memory in the interface control unit at this moment (step S711). After that, it goes to write data (step S713), and outputs to the computer system (step S715).

If the memory to be shared is determined not to be occupied (no), the memory control unit addresses the shared memories (step S719). After that, it is to write data in the shared memories (step S713). As the description above, the data is written to equal amounts into the addresses of the shared memories, or written in the memories in sequence (the second memory is standby for writing data as the first memory is filled). The data is finally outputted to the computer system (step S715).

In practice, the externally-connected audio apparatus having the MCU may choose the second memory to be the shared space, and a special function register (SFR) is added to configure the shared memories' addresses. After that, the MCU controls the parameters for the firmware, and stores the parameters, such as a USB Descriptor, in the special function register. The read/write process of the shared memories is controlled by MCU when a USB ISO Transfer is off. Further, the MCU will release the use privilege of the memory control circuit (or arbiter) to the interface control unit when the USB ISO Transfer works.

To sum up the above description, the present invention provides an externally-connected audio apparatus and method for processing audio signals thereof. A memory control circuit is particularly disposed in the externally-connected audio apparatus, and used for determine whether the shared memory is available or not. This structure effectively increases the audio data throughput and enhances the audio quality by using the memory-shared mechanism without extra increment of memory.

While the invention has been described by means of a specification with accompanying drawings of specific embodiments, numerous modifications and variations could be made thereto by those skilled in the art without departing from the scope and spirit of the invention set forth in the claims.

What is claimed is:

1. An externally-connected audio apparatus, comprising: an interface control unit electrically connected with a computer system through a connecting interface, and electrically connected to a first memory used for buffering signals;
an audio interface module, electrically connected to the interface control unit, used for performing a digital-analog conversion after receiving the signals, and electrically connected to a second memory for buffering the signals, so as to output or receive the audio signals; and
a memory control unit, electrically connected to the first memory and the second memory, used for allocating the space occupied by the first memory and the second memory.

2. The apparatus of claim 1, wherein the audio interface module includes an analog audio interface unit and a digital audio interface unit, and the audio interface module connects to an external analog or digital audio source or to an audio receiving apparatus via one or more output/input ports by way of the analog audio interface unit and the digital audio interface unit, and then performs digital-analog conversion by the analog audio interface unit.

3. The apparatus of claim 1, wherein the interface control unit is a USB control circuit, and electrically connects to the computer system through a USB port.

4. The apparatus of claim 1, wherein the operating modes of the memory control unit include a sharing mode and an independent mode.

5. The apparatus of claim 4, wherein memory control unit is activated as the sharing mode when the second memory is idle.

6. The apparatus of claim 4, wherein the memory control unit is activated as the independent mode when the audio interface module performs the analog-digital conversion and the second memory is not idle.

7. The apparatus of claim 1, wherein the memory control unit controls a data bus in each memory, allocates an address bus and the data bus to each memory, and controls the address to be written.

8. The apparatus of claim 1, wherein the audio interface module performs analog-digital conversion through a build-in micro-processing unit.

9. The apparatus of claim 1, wherein the memory control unit integrates both the first memory and the second memory of the apparatus in its circuitry.

10. A method for processing audio signals for an externally-connected audio apparatus, comprising:
receiving signals transmitted from a computer system;
converting the received signals to the signals in compliance with a specific interfacing format;
determining a usage status of each memory of the externally-connected audio apparatus by means of a build-in memory control circuit;
if the memory to be shared is occupied by other applications, the memory control circuit is activated as an independent mode, and then to address a single memory and write data on the memory;
outputting audio;
if the memory to be shared is not occupied, the memory control circuit is activated as a sharing mode, and then to address the shared memory;
writing data on the shared memory after arbitrating the memory; and outputting audio.

11. The method of claim 10, wherein the connecting interface between the externally-connected audio apparatus and the computer system is a serial interface.

12. The method of claim 10, wherein the memory control circuit is used to control a data bus of each memory of the externally-connected audio apparatus, and allocate an address bus and the data bus of each memory.

13. The method of claim 12, wherein an added buffer is used to configure the addresses for the memory to be shared in the sharing mode, and data is written to equal amounts into each memory.

14. The method of claim 12, wherein an added buffer is used to configure the addresses for the memory to be shared in the sharing mode, and the data is sequentially written on each memory.

15. The method of claim 10, wherein the memory to be shared is occupied when the externally-connected audio apparatus performs an analog-digital conversion in the independent mode.

16. A method for processing audio signals of an externally-connected audio apparatus, comprising:
receiving audio signals;
not performing an analog-digital conversion if the audio-signals are digital signals;
performing an analog-digital conversion if the audio signals are analog signals;
detecting a usage status for the memories to be integrated in the externally-connected audio apparatus;
determining whether the memory to be shared is occupied or not;
addressing the single memory if the memory to be shared is occupied;
writing data and outputting the data to a computer system;
addressing the integrated memories if the memory to be shared is not occupied;
arbitrating the memories and writing data; and
outputting the data to the computer system.

17. The method of claim 16, wherein the steps of detecting the usage status and addressing each memory are performed by means of a memory control circuit.

18. The method of claim 17, wherein the memory control circuit controls the data bus for each memory in the externally-connected audio apparatus, allocates an address bus and the data bus to each memory, addresses the memories, and uses an added buffer to configure the addresses of the shared memories if the memory to be shared is not occupied.

19. The method of claim 18, wherein the data is written to equal amounts into the shared memories.

20. The method of claim 18, wherein the data is written into the shared memories in sequence.
